(19) United States
(12) Patent Application Publication
(10) Pub. No.: US 2005/0244240 A1
(43) Pub. Date: Nov. 3, 2005

(54) Router attachment

(76) Inventor: Lance Rodney Sheffield, Sevenoaks, Kent (GB)

Correspondence Address: David Silverstein;Andover IP Law, Suite 300, 44 Park Street, Andover, MA, 01810, US

(21) Appl. No.: 10/529,952

(22) PCT Filed: Oct. 3, 2003
(86) PCT No.: PCT/GB03/04272

§ 371 Date: Apr. 1, 2005

(30) Foreign Application Priority Data
Oct. 3, 2002 (GB) 02228484
Oct. 25, 2002 (GB) 02248631

(51) Int. Cl. B23C 1/20

(52) U.S. Cl. 409/182

(57) ABSTRACT

An adjustable attachment which can be used with routers or incorporated in routers making them safer, easier to use and more effective consists of a two part or compound base system rather than the single traditional router base plate, with each part separately performing the essential functions of the existing base plate. Separating the functions allows the router to be used with a number of interchangeable base plates with each individual plate being specially designed for the job in hand rather than being a general compromise solution. The attachments can include depth control systems.

The present invention relates to adjustable attachments which can be used with routers making them safer, easier to use and more effective and to routers which incorporate or are modified by the attachments or have the attachments attached thereto.

### BACKGROUND

A router is a tool which is used for cutting precise edges, grooves or shapes in a workpiece.

With a typical straight or curve line cutting guide, the workpiece is clamped securely to the guide and the required cut is made. Several U.S. patents have been issued which offer guides for routers. Most of these prior art devices lack the necessary flexibility, adaptability, and variety of applications. U.S. Pat. Nos. 4,966,507, 4,434,824, 4,281,604, 4,630,657, and 4,215,731 describe such guides.

In a typical router there is a base plate attached directly to the router columns so that the router is raised and lowered on the columns and the router bit passes through a hole in the base plate into the work piece. The underside of the base plate has a smooth low friction material attached to allow easy movement of the router over the work piece.

With a fixed base plate its overall size and shape has to be a compromise between the conflicting requirements of stability in use and making the total unit small enough to get into tight corners or to work close to obstructions. Transportation and storage have also to be considered.

Standard equipment supplied with most routers include:—Adjustable guides, adjustable depth stops and provision to accept guide bushes mounted concentrically to the cutter and protruding below the base plate, allowing the router to follow a guide or template fixed between the router and workpiece.

There are a number of routing operations that prove difficult for both the inexperienced and experienced user alike. These are generally related to lack of stability of the router when working close to edges and ends of components.

Formation of sunken recesses in a workpiece have to be carried out in a number of operations using a series of templates, with the width of template aperture being restricted to less than half the diameter of the base plate, so that the router remains fully supported.

It is possible to provide greater stability by attaching larger or extended plates to the underside of the traditional router, but this causes a number of problems:—
a) Reduction of cutting depth by the thickness of the plate or board.
b) Difficulty of achieving adequate dust and debris removal.
c) As plate size increases so generally must thickness. Guide bushes attached to the base plate no longer protrude below the surface making them inoperative. Guide bush recess can be formed in the plate, but this requires accurate machining of the recess and positioning of the plate to ensure that cutter and bush are concentric.
d) The adjustable guides and trammels supplied with standard routers cannot be used in conjunction with extended bolt on plates.
e) Without easy to use guide systems attached to the router, remote guides or templates have to be employed.

The recent development of router tables where the router is mounted to the underside of a work surface with the cutting bit protruding upwards through the top, assists in guiding the workpiece, by provision of separate adjustable guides, but many of the previously mentioned problems still remain. Also the safety feature afforded by the plunge capability of the standard router is lost when thus mounted, leaving a high speed rotating cutter exposed. Fine height adjustment of the cutter is also difficult as the standard depth controls being attached to the router are hidden beneath the work surface.

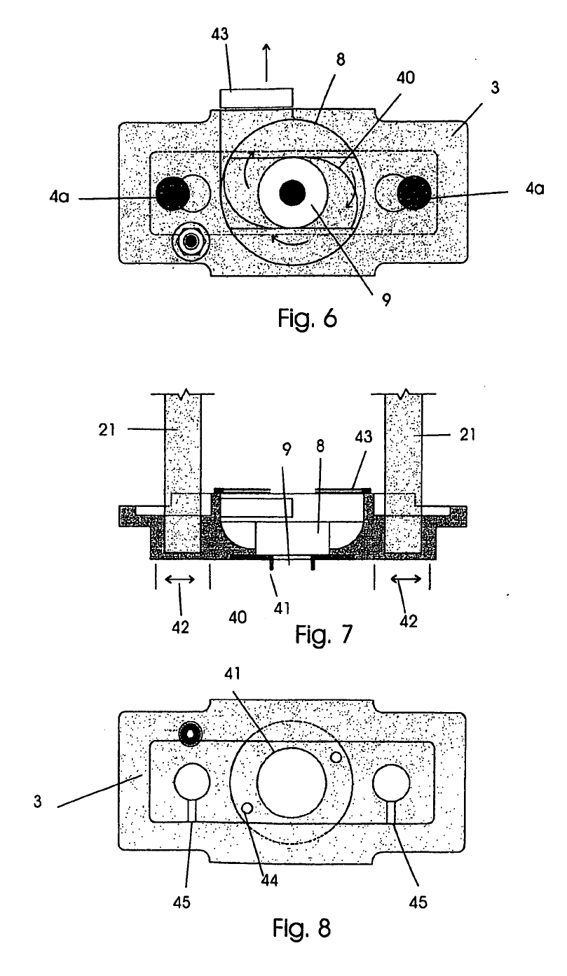

The formation of deep recesses and slots in hard materials using small diameter cutters require the router cutter to be plunged down in incremental steps with machining being carried out in a number of stages before reaching the final depth. To achieve a high quality finish the last few cuts need to be smaller than the earlier stages. Existing depth stop design e.g. as shown in U.S. Pat. No. 6,079,915—FIG. 6D Sheet 9 allow just two incremental stages to be achieved without the need of resetting the adjusters. (Nos. 602 and 603 on the above drawing) This can be very time consuming especially when there are many slots or recesses to be formed and in addition this manual adjustment has to be repeated whenever there is a change in overall depth of cut or cutter change.

With the more expensive machines there are elaborate micrometer adjustment devices attached to provide fine adjustment control over final depth of cut. Yet even with these sophisticated devices, it is extremely difficult and or time consuming to achieve a particular depth of cut, as the insertion of tape measure or standard vernier calipers between the depth stop (No. 1201) and striking plate (No. 603 of U.S. Pat. No. 6,079,915) is virtually impossible due to close proximity of adjacent parts. Using the built in micrometer adjusters to set overall depth requires multiple readings and many turns. The alternative method is to carry out a trial run measure of the depth of cut and adjust accordingly using the micrometer screw adjuster. Changing the cutter requires the whole operation to be repeated.

We have now devised modifications to the standard type plunge router or attachments for use with such routers which reduces or overcomes these problems.

The Invention

Basically the invention consists of a two part or compound base system rather than the single traditional router base plate, with each part separately performing the essential functions of the existing base plate. These functions being delineated as follows:—
1. Support to router columns, depth control, removal of dust and debris together with the positioning and support to guide bushes.
2. Interface with the workpiece including holding and support to adjustable guides and trammels.

Separating the functions thus allows the router to be used with a number of interchangeable base plates with each individual plate being specially designed for the job in hand rather than being a general compromise solution.

The connection between these two components is a simple plug and socket arrangement combined with securing bolts or other locking means to prevent separation in use. A standard plug and socket configuration allows an individual router to be used with a wide range of different plates it also allows different routers to be used with those same plates.

According to the invention there is provided an attachment for a router comprising columns along which a router cutting bit can be raised and lowered into the material to be worked so that the depth of cut can be controlled which attachment comprises a base plate for the router which is in two separable parts, the first part is adapted to support the router columns, and the second part adapted to interface with the workpiece.

The first part can include depth control means and/or means for removal of dust and debris and/or means for positioning and support to guide bushes and the second part includes holding and support means to adjustable guides and trammels.

In use the first component (the insert) forming the plug is attached to the router columns and the second component (the plate), containing the socket, fitted around it and thereby attached to the router; the router can then be operated as a conventional router and, when being so used, the level of the lower surfaces of both components which are in contact with the workpiece are level, subject to allowances for thickness for the router bush supporting plate. To accommodate difference thickness of plates, spacer or shims can be used between the top surface of the plate and the insert.

The Insert—Main Construction

The insert can be machined from any solid material such as wood, metal or plastics material, but economically it can be made from metal or rigid plastic material, cast to the desired shape. Preferably there is a rebate formed within the component so that the lower part, closest to the workpiece, is smaller forming the plug and will pass though the aperture in the plate, forming the socket, to provide a snug fit while the top larger section being of greater width would be positioned on or above the upper surface of the plate.

There is a shaped recess within the insert that forms a plenum chamber to aid in the removal of dust and debris at the bottom of which recess there is a hole through which the router bit can pass.

Preferably there is a further recess in the underside of the insert that will allow a guide bush to be fitted within the recess when so required.

The support arrangements for the router columns need to be at varying distances apart and of varying sizes to accommodate different routers. Therefore, in the general case, the insert around this area will be formed solid to allow subsequent drilling for the column supports. When manufactured for a particular router the insert can be modified, being cast or formed with the router column support holes already formed.

The method of locking the columns within the drilled holes will be dependant upon the design of the columns. These attachment means can be in the form of bolts inserted perpendicular to the columns and locking against the side of the columns or could be fixed to the ends of the columns.

The Insert—Dust & Debris Removal

In use the cutter can cause dust and other particulate debris to be formed which are a nuisance and a potential hazard. In order to remove this dust and other debris a vacuum or suction system is usually employed; generally, however, because of the looseness of fit of the router cutter and the template only limited suction is likely to be achieved.

In order to facilitate removal of this debris there can be an upwardly curving ramp leading away from the hole in the insert through which the router bits operates. In use, as the router bit rotates, the debris is thrown out along and up the ramp. To remove the debris from the ramp preferably there is an outlet in the insert through which the debris will tend to be thrown by centrifugal force; preferably this outlet is positioned substantially tangentially to direction of rotation of the router bit. There can be a suction means in the outlet or connected to the outlet to assist in this removal and maintain low levels of dust in the surrounding atmosphere.

The Insert—Dust & Debris Removal—Sealing Ring

To further improve the effectiveness of the dust and debris removal system, the invention also includes the provision of a flexible sealing ring of individual fibres anchored to a circular ring. Each fibre will be angled in the direction of the rotation of the router cutter so allowing the fibre to be deflected sideways when the cutter passes though the seal. This component is designed to be semi-disposable as the ends of the individual fibers will be gradually cut away by the cutter, thereby enlarging the hole; when a smaller cutter is used, then the seal can be replaced.

To construct the sealing ring, a ball of deformable material such as an expanded plastic, e.g. expanded polystyrene, is placed within an inner ring and spaced apart from a larger ring by means of breakable spokes. Fibre or wire is wound around the ring and the ball in a series concentric loops or turns to produce the desired density of fibre material. The wound ring will then be placed in an injection moulding machine that will simultaneously mould a outer ring around the component to encapsulate and anchor the fibres, crush and rotate the ball thus breaking the temporary spokes. A circular cutter will then cut the fibres to form inner aperture and remove the inner ring and ball. A flat sealing element is therefore obtained. The dimensions are chosen so that it can fit around the router blade within the recess in the insert. As the router in plunged to its full operating depth the fibres will be pushed aside, by the router casing.

The Insert—Router Depth Control

Previous router depth control devices generally work on the principle of an adjustable bar or device attached to the router body that descends with the router until the end of that bar or device strikes a fixed or adjustable protrusion mounted on the upper surface of the base plate, thus preventing further downward movement of the router and cutter.

The invention also provides a simplified and improved device for controlling the depth of cut of the router by limiting the downward movement of the router body down the columns which device comprises a control bar attached to the base which can be moved relative to the base; the router being able to slide relative to the control bar and the router being lockable to the control bar so that, when locked to the control bar vertical adjustment of the control bar will adjust the depth of the cut a corresponding amount.

Rather than having a bar mounted on the router body, the control bar is adjustably anchored to the base by means of a threaded bolt or rod or other means that allows the vertical position of the control bar relative to the base to be varied.

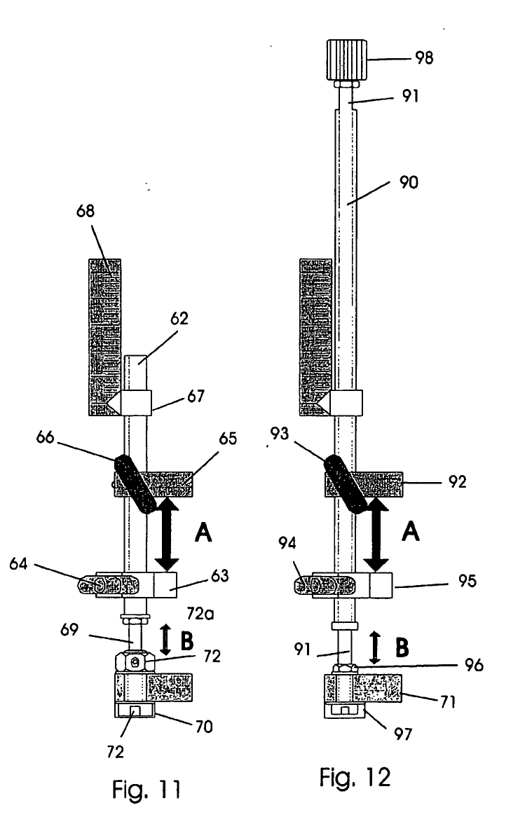

Depending upon the exact configuration of the device, the vertical position of this control bar can be varied either by (i) in example A (FIG. 11)—turning the lower assembly mounted in the insert which has an internal threaded section either by using a open ended spanner from above or using an hexagonal Allan or other key from below, or (ii) in example B (FIG. 12)—turning the internal rod directly using the knob at top or by again using hexagonal Allan key from below.

The control bar is prevented from turning by an external keyway slot or by the cross section of the bar being non-circular. This vertical movement is only required to provide the fine depth control.

The control bar can have mounted on it two collars (i) a first collar which can slide up and down the bar and is lockable to the bar, (ii) a second collar attached to the router body through which the bar slides and to which the bar can be locked.

Preferably there is a pointer slidably attached to the bar which can mark a location on a scale. In addition there can be a scale attached to first collar that will provide a direct reading of depth of cut.

The Insert—Router Depth Control—Operation

In use, in order to control the depth of a cut by the router blade, the router blade is placed in contact with the material which is to be cut, i.e. the bit engages to the surface and the second collar on the router body is locked into position on the bar. The gap between the first and second collars is adjusted to the approximate depth of cut by moving the first collar and locking it in position on the control bar. The fine depth control is then adjusted to move the control bar so that the gap between the first and second collars is the exact depth of cut required. When the router bit is operated, the second collar is unlocked and the router body attached to the bit slides down the router columns so that the bar then slides through the second collar and, when the first collar comes into contact with the second collar, the bit has cut into the material to the exact depth.

The Insert—Incremental Plunge Depth Control

The formation of deep recesses and slots in hard materials using small diameter cutters require the router cutter to be plunged down in incremental steps with machining being carried out in a number of stages before reaching full depth. To achieve a high quality finish the final cuts need to be smaller than the earlier stages. While the above may be an extreme case, many routing operations involve machining in a series of stages.

The invention also provides an incremental plunge depth control device for controlling in incremental steps the depth of cut in a router blade in a router which router comprises a router body and a base plate which device comprises a hollow tube, cartridge or template around the outside of which is a series of incremental spiral steps.

In this embodiment of the invention the device can optionally be added to the router depth control as described in the previous section.

The device preferably consists of a hollow tubular interchangeable cartridge made from injection moulded plastic or cast metal around which is formed a series of spiral steps or treads. A lug, bracket or stop built into the router casing engages against these steps or treads and prevents further downward movement of the router and cutter. Rotating this cartridge by a set amount presents the next tread down and so allows the router to be plunged a further amount until the lug again engages against that next tread. After each machining operation the cartridge is rotated a further amount allowing greater depth to be reached in incremental stages.

The individual rise between each successive step governs the incremental plunge depth. Therefore lower down the spiral the rise is less allowing very fine final machining and thereby achieve the best possible surface finish. Where shallow routing operations are being undertaken only the lower steps are used. As depth increases so will the number of steps employed increase.

The ideal plunge depth is dependant on a number of factors. The main being the diameter and type of cutter as well as the hardness of the material being worked. To accommodate these variations a number of interchangeable cartridges will be required with different rise between successive steps, as shown in FIG. 14 components 25a-25c inclusive, allowing the user to look up a table and so select the most appropriate cartridge.

In this embodiment of the invention the cartridge is mounted on the first collar of the Router Dept Control device, which can slide up and down the main control bar and is lockable to the bar. This collar is extended to include the support to the cartridge and an indexing system to allow rotation in a series of distinct steps. The lug or bracket is attached to the side of the second collar and therefore the router body.

Another embodiment of the invention would mount a similar replaceable cartridge or template in place of the existing three head turret arrangement as generally employed by standard lower to medium cost plunge routers. Depending upon the design of the router the spiral step arrangement could be around the outside of a tube as above or equally it could be around the inside a larger diameter tube or container.

With higher performance routers used professionally the replaceable cartridge or template could in itself be adjustable, with the height of each step in the spiral being able to be varied in height, either by using individual building blocks, or modular components or by other means. This would allow the user to set up a range of cutter depths for a particular operation or jig, that would be stored away with the jig, ready for the next time the jig is used, thus saving set up time.

The Plate

In the simplest embodiment of the invention, the plate can be made of any material, e.g. metal, wood, plastics material being either transparent or opaque etc. and can simply be a plate or sheet, board etc. of any size so that the router can be used with any size of work piece. In particular it facilitates the working at or near the edge of work pieces without the base plate losing support or in the cutting of medium to large recesses using just a simple template. The necessary work to create the socket or aperture in the board is easily accomplished using standard routers, guide bush combined with simple templates.

Where the plate is to be a manufactured component rather than just a simple flat sheet, its construction will be dependant upon its designed use and could include facilities to hold guides or trammels in any desired arrangement or location.

In another embodiment of the invention the plate can be a sheet of board or other material which can be supported on supports or on a workbench such as a “Workmate” (RTM), with the router positioned beneath the board, i.e. the router operates upwards with the workpiece on the sheet or board above the router. This enables a router workbench to be assembled on site, as all that is required is a piece of board and two supports. An aperture is then cut in the board into which aperture the insert, attached to the router columns, fits. The router is the simply bolted to underside of the board, so the router operates upwardly with the work piece placed on top of the board.

The depth control system having fine adjustment capability that can be adjusted from either bottom or top will make fine adjustment far easier when the router is placed below a work surface.

In yet another embodiment of the invention the stability or a router would be greatly improved when used in conjunction with dovetailing jig or similar devices. The plate would be extended away from the operator and pass between the workpiece and an additional horizontal rail. This could then support the router even beyond the edge of the jig so that on entry into the jig the router is maintained in exactly the correct plane, thus prevent accidental damage to the jig and cutter should the operator momentarily loose concentration. Existing jigs are very prone to damage due to such operator error.

The Plate and Patent Application PCT/GB2003/000353

The router attachment is especially useful when used in conjunction with the device of Patent Application PCT/GB2003/000353, the contents of which are hereby included by reference.

This device uses a thin steel plate to support the router over a recess. The insert therefore protrudes below the plate and allows the router assembly to be lowered nearer the workpiece than would be possible with a traditional base plate arrangement while horizontal movement of the whole plate assembly is constrained by the sides of the recess.

This application discloses a router attachment which comprises a base, a router holding means for holding a router and a guide pin attached to the router holding means, the router holding means being pivotally attached to at least two spaced apart struts or plates at a first pivot point for each strut or plate with each of the struts or plates being pivotally attached to a second pivot point spaced apart from the first pivot point and mounted on the base, the first and second pivot points being arranged so that the struts or plates remain in fixed relative orientation to each other on movement of a router, held in the router holding means.

The first and second pivot points can form the corners of a parallelogram and with movement of the router in the router holding means the points remain the corners of a parallelogram.

In one embodiment, each of the second pivot points is pivotally and slidably connected to a bar so they can move along the bar whilst being held a fixed distance apart. The said second pivot points can be held a fixed distance apart by being attached to a sleeve rotatably and slidably mounted on the bar.

The bar can be in the form of a rod or a similar structure.

Alternatively, the second pivot points can be fixed and the struts or plates are extended beyond the second pivot points and the extended part of the struts or plates connected together.

The base preferably comprises a non-metal plate with a recess formed in it. Preferably there is a router plate which can hold a router and the router plate can detachably fit into the said recess. The router plate can then be located in the base and the router plate connected to the struts. This enables the router plate and router to be easily fitted into the base. Preferably the router plate enables the router to be positioned in a variety of positions, so increasing the configurations of cuts, grooves etc. made in the material. The guide pin can be attached directly to the router plate.

Preferably the first pivot points are able to move to the side of the bar remote from the said recess in order to give greater range of movement, i.e. the first pivot points can move over and/or under the bar, i.e. to either side of the bar.

There is preferably a second recess, which is a pattern holder recess, into which a guide plate incorporating the pattern to be followed can be mounted so that the guide pin can easily follow the pattern. Preferably the guide plate is adjustable inside the pattern holder recess so that the adjustment enables the pattern to be moved relative to the base so a series of locations for the cuts can be easily made. This is useful for making a series of parallel cuts or grooves.

By keeping the attachment secured in the same position over a workpiece and by changing the pattern and or cutter complex, shapes can be machined which are not possible with existing jigs.

Preferably the pivots forming the pivot points are detachable so that the router plate can be removed; this enables a range of routers or similar tools to be used with the attachment and enables the router to be easily removed from the attachment.

Embodiments of the invention is illustrated in the drawings in which

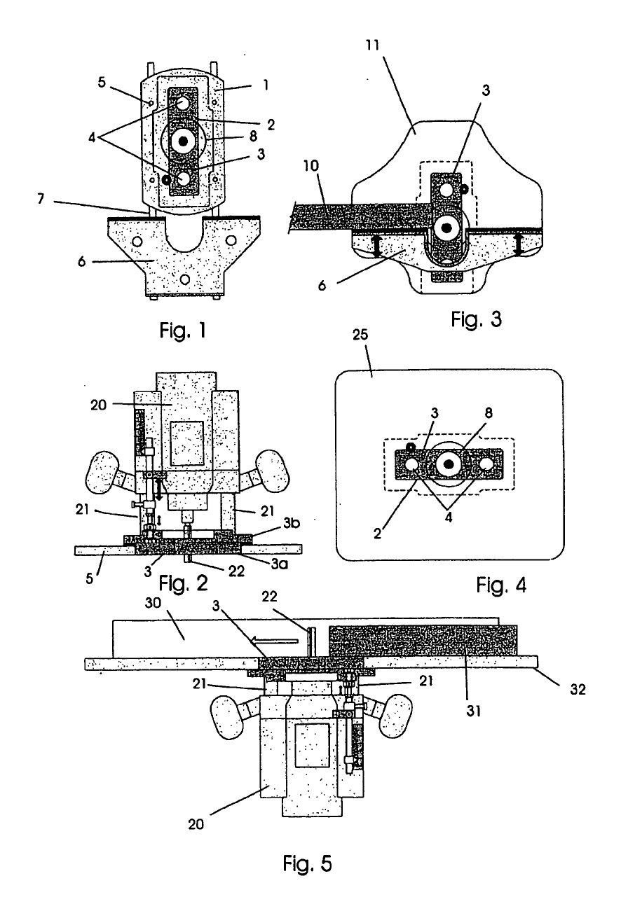

FIG. 1 shows a plan view of the attachment;

FIG. 2 shows a side view;

FIG. 3 shows the use with “wings”;

FIG. 4 shows a partial plan view of another embodiment;

FIG. 5 shows a side view of the use with a workbench;

FIG. 6 shows a plan view of the attachment showing the ramp;

FIG. 7 shows a side view of FIG. 6;

FIG. 8 shows an alternative fixing;

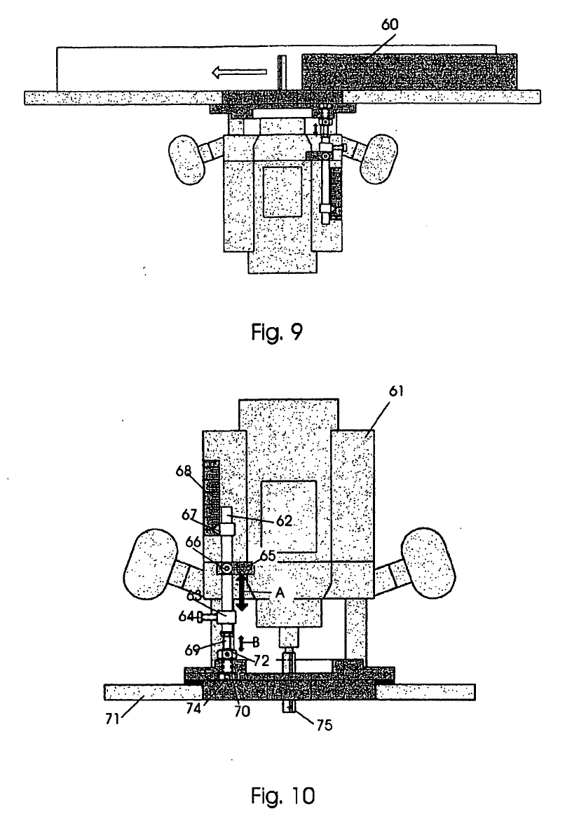

FIG. 9 shows a depth control attached to the router;

FIG. 10 shows a view of FIG. 9 with a workbench;

FIG. 11 shows the depth control in detail;

FIG. 12 shows a different embodiment of the depth control in detail;

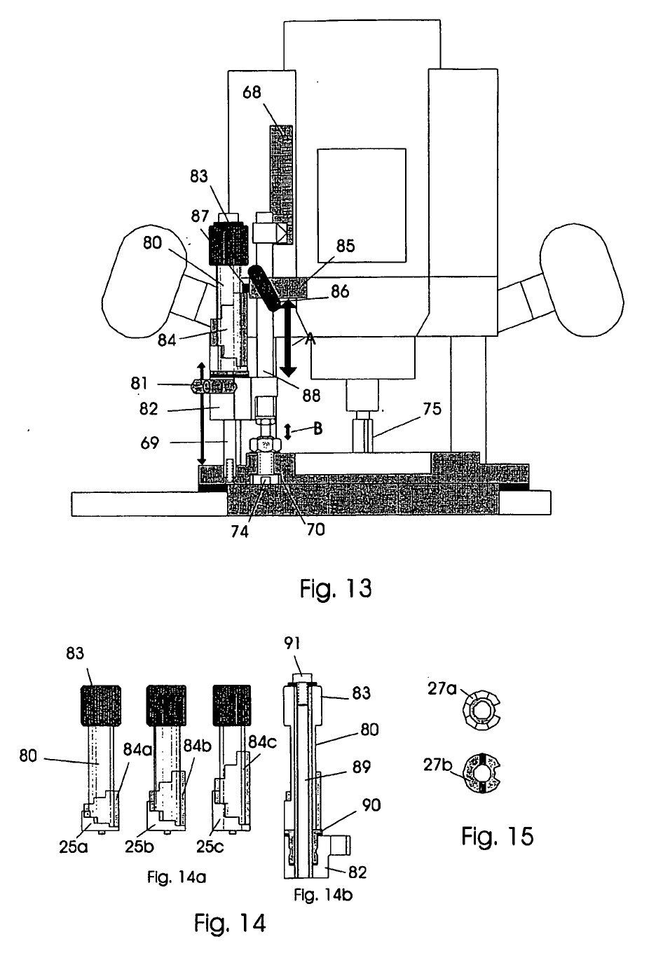

FIG. 13 shows an incremental depth control;

FIG. 14 shows component parts of the incremental depth control;

FIG. 15 shows a plan view of the replaceable cartridge of FIG. 14;

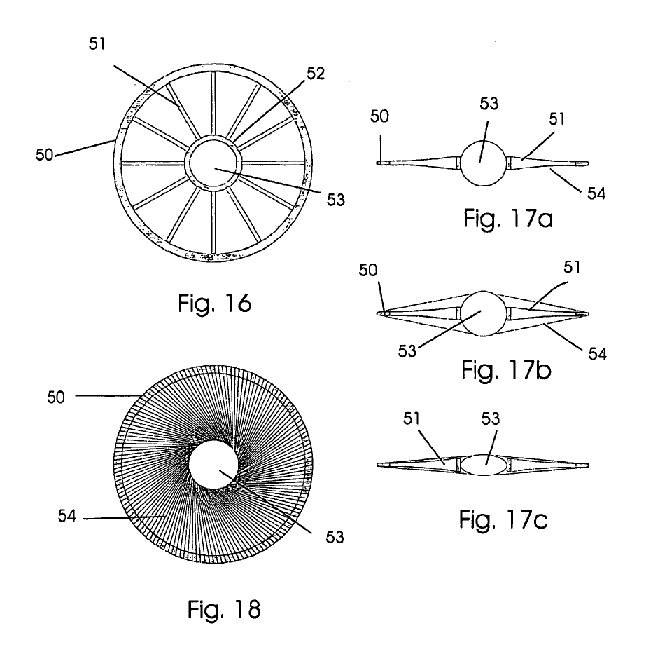

FIG. 16 shows the support for forming the filter element;

FIG. 17 shows a side view of FIG. 16

FIG. 18 shows a plan view of the formed filter

Referring to FIG. 1 a first component (1) consists of a plate with an aperture (2) within it into which second component, insert (3) fits; the insert has an inner section (3a) and an outer section (3b). The insert (3) in use, is attached to router columns by attachment at locations (4). The plate (1) can be attached to the router by fixing means (5). The attachment can be used with a moveable guide (6) which can slide on long supports (7) clear of the router base. There is a guide bush recess in (3) shown at (8).

Referring to FIG. 2 the router (20) has a router bit (22) and can slide up and down on columns (21). In use the insert (3) is attached to the router columns (21) at locations (4) (FIG. 1) and fits into the aperture (2) in plate (1); the plate (1) is attached to the router at (5). The router and attachment is placed on a workpiece so that, as the router (20) moves up and down on columns (21), the router bit (22) engages the workpiece. If a different plate (1), e.g. of different size, etc. is required, then the plate is detached from the router and replaced.

Referring to FIG. 3, when the edge of the workpiece is being worked on, as can be seen, the wings (11) support the workpiece (10).

Referring to FIG. 4 this shows the plate (1) of FIG. 1 replaced by a large sheet (25) where there is large void to span.

Referring to FIG. 5 a large board (32) is attached to the router (20) and the insert (3) fitted within an aperture within the board and attached to router columns (21). The board (32) is supported on supports so that the router is fixed e.g. by bolts etc. beneath the board and operates upwards. A workpiece (31) is placed on (3) and (32) as shown and located by guide fence (30). The router bit (22) can then operate on the workpiece (31) as it is moved. The equipment can be assembled on site as, all that is required is that an aperture is cut in the board into which the component (3) fits and the board attached to the router (21). Thus a workbench is easily assembled and can be of any desired size,

Referring to FIGS. 6 and 7 in the plate (3), there are alternative fixing points (4a) so that the plate can be fixed to different routers. Inside the depression (8) in the insert (3) is an upwardly curving ramp (40) connected to an exit (43) so that, as a router bit operating through hole (9) in guide bush (41) rotates, debris formed is spun up the ramp by centrifugal force and is ejected through (43) where it can be removed, e.g. by suction etc. There is a nylon brush sealing disc (43) preventing debris from flying up out of (8) while reducing loss of suction. The sealing disc is shown in detail in FIGS. 14 to 16. The range of points for attaching to the router columns (21) is shown at (42) in FIG. 7.

Referring to FIG. 8, this shows fixing points for the guide bush (41) at (44) and column anchor points (45) for attaching the insert (3) to the columns.

FIG. 9 shows the router being use in an upward direction, e.g. on a router table with a workpiece (60).

Referring to FIGS. 10 and 11, which show the depth control, a router body (61) (FIG. 9) has a bar (62) attached to it by first collar (65) which is fixed to the router body. On the bar (62) are the first collar (65) which can be locked to the bar by bolt (66) and second collar (63) which can be screwed to the bar by bolt (64), when the collar (63) is not screwed to the bar the bar (62) can slide through the collar (63) and the router body can move along the router columns. There is a pointer (67) slidably attached to the bar which indicates a location on scale (68).

At the lower end of bar (62) there is a threaded section (69) which engages a nut (70) in the router plate (71); there is an adjustment nut (72) which can lock the bar in position on the plate and a screw head at (74) operated from beneath the plate on the end of (70) which turns (69); there is a lock nut at (72a).

In use the gap (A) between (63) and (65) is set to about the required distance using the scale (68) and the collars (63) and (65) locked in place. The fine adjustment is carried out by turning the threaded section (69) of the bar in the nut (70) by turning the screw head (74) until the bar (62) moves varying the distance B so the precise distance (A) is obtained and the bar is locked in position by nut (72). This accurately fixes the distance the router bit will cut into the workpiece from its starting position.

The material to be cut is placed beneath the router plate (71), the screw (66) is loosened and the router started and moved down the router columns; the bit (75) engages the surface of the material and, when the collar (65) slides down the bar (62) to abut collar (63), the router bit has penetrated the material to the precise distance (A).

Referring to FIG. 12 this shows a different embodiment of the depth control; a bar (90) is attached to the router body by collar (92) fixed to the router body. On the bar (90) are the first collar (92) which can be locked to the bar by bolt (93) and second collar (95) which can be screwed to the bar by bolt (94). When the collar (95) is not screwed to the bar (90) the bar (90) can slide through the collar (95) and the router body can move along the router columns. There is a pointer (67) slidably attached to the bar which indicates a location on scale (68).

At the lower end of bar (90) there is a threaded section (91) which engages a nut (97) in the router plate (71); there is a nut (96) which can lock the bar in position on the plate. The section (91), which need not be threaded along its whole length, extends beyond the end of bar (90 and there is a knob (98) on the end of (91).

In use, the gap (A) between (92) and (95) is set to about the required distance using the scale (68) and the collars (92) and (95) locked in place. The fine adjustment is carried out by turning the threaded section (91) of the bar in the nut (97) by turning the knob (98) moving the bar (90) and varying the distance B until the precise distance (A) is obtained and the bar is locked in position by nut (94). This accurately fixes the distance the router bit will cut into the workpiece from its starting position.

The material to be cut is placed beneath the router plate (71), the screw (93) is loosened and the router started and moved down the router columns; the bit engages the surface of the material and, when the collar (92) slides down the bar (91) to abut collar (95), the router bit has penetrated the material to the precise distance (A).

Referring to FIGS. 13 and 14b, there is an attachment (84) which is attached to extended collar (82) that forms the Stop Block which is locked in place on the Control Bar (88) by bolt (81). There is a column (69) fixed to the router base plate that provides stability to the device on which extended collar (82) is also slidably mounted. Tube (89) rigidly fixed to (82) and also slides on (69). Near the lower end of tube (89) and within recess in collar (82) is a simple indexing device (90), with a slot in the top surface to link with the template or cartridge (80) that therefore rotates with the indexing device. The template or cartridge being interchangeable is held in place with a bolt (91) threaded to the top of tube (89).

The template or cartridge (80) is formed of a tube (84) having a spiral series of steps (87) formed on its outside, there is a knurled knob (83) on the top end of the tube that allows to user to rotate the template or cartridge an indexed amount. There is a lug or bracket (87) fixed to collar (85) that forms part of the router body and therefore descends with the router when the cutter is fed into the work piece.

Details of the template or cartridge are shown in FIGS. 14 and 15. Referring to FIG. 14a, that shows three possible variations of the template or cartridge 84a, 84b and 84c, each variation having different rise between sequential steps 25a, 25b and 25c. Referring to FIG. 14b this shows a vertical section though the assembly. Referring to FIG. 15 this shows the cross section through the cartridge indicating the spiral step positions and a notched cut out that allows the cartridge to be slid over tube (89) missing the projecting lug or bracket (87) during installation or removal. In 28a the connecting lugs between cartridge and indexing mechanism are shown.

During general plunge operation of the router, block (82) is locked into place on the control bar (88) giving the lowest position that the router can descend as underside of bracket (85) hits top of collar (82). With the incremental plunge depth device bypassed the lug (87) passes down the notched cut out. To bring the unit into operation the user simply rotates the assembly by turning knob (83) one or more indexed clicks. This interposes a tread or one of the spiral steps in the downward path of lug (87) and therefore prevents further movement in the downward direction of the lug and router body. Further rotation presents a lower step and therefore allows the lug and router to descend the same amount as the rise or fall between steps.

Referring to FIGS. 16, 17 and 18, that show details or the nylon brush seal. In plan view in FIG. 16 consists of an outer ring (50) and an inner ring (52) connected by spokes (51). There is a compressible polystyrene ball (53) in the middle. Fibres (54) are wound over (50) and (53). To form the filter, the ball is crushed with rotation to break spokes (51), the ball is removed and the filter structure of FIG. 18 formed. The cross sectional views as the structure is formed are shown in FIGS. 15a to 15c.

1-45. (canceled)

46. A router control attachment for a router apparatus, which router apparatus includes router column members along which a router cutting bit can be raised and lowered into contact with a material to be worked such that the depth of a router cut can be controlled, the said attachment comprising a base plate for the router apparatus having two separable parts wherein the first part is adapted to support the router column members, and the second part is adapted to interface with the material to be worked by the router.

47. An attachment according to claim 46 further wherein the first part includes at least one element selected from the group consisting of a depth control means; removal means for removal of dust and debris; and means for positioning and supporting guide bushes.

48. An attachment according to claim 46 further wherein the second part includes holding and support means for adjustable guides and trammels.

49. An attachment according to claim 46 further wherein the first part comprises an insert which can removably fit within an aperture in a sheet or plate and which insert has a router column attachment means adapted to be attached to the router column members and a hole through which a router cutting bit can pass.

50. An attachment according to claim 46 wherein said attachment comprises: (i) a first component which consists of a plate having an aperture in it, which plate is attachable to the router apparatus and, (ii) a second component which comprises an insert which removably fits within the aperture of the first component and which has router column attachment means adapted to be attached to the router column members and which insert has a hole through which a router cutting bit can pass.

51. An attachment according to claim 50 wherein the insert has an inner section and an outer section such that the inner section fits within the aperture in the plate to form a tight fit, and the outer section of the insert fits over the upper surface of the plate.

52. An attachment according to claim 50 wherein the aperture in the plate is in the form of a socket and the insert is a plug which fits within the socket.

53. An attachment according to claim 50 wherein a rebate is formed within the insert so that the lower part, closest in use to a material to be worked, forms a plug and will pass though the aperture in the plate, which aperture forms a socket, to provide a tight fit, while the top larger section, being of greater width, can be positioned on or above the upper surface of the plate.

54. An attachment according to claim 53 wherein a further recess is formed in the underside of the insert to allow a guide bush to be fitted within the recess when so required.

55. An attachment according to claim 50 wherein the first component is a sheet of board or other material which can be supported on supports or on a workbench with the router apparatus positioned beneath the board and attached to the board such that the router apparatus operates upwards with the material to be worked on the sheet of board above the router.

56. An attachment according to claim 50 adapted for use in conjunction with a dovetailing jig or similar devices wherein the plate is extended away from an operator and passes between the material to be worked and an additional horizontal rail which can support the router apparatus beyond the edge of the jig so that, on entry into the jig, the router is maintained substantially in the correct plane.

57. An attachment according to claim 50 wherein a shaped recess is formed within the insert to form a plenum chamber to aid in the removal of dust and debris and also wherein, at the bottom of such shaped recess, there is a hole through which a router bit can pass.

58. An attachment according to claim 57 wherein, in order to facilitate removal of debris formed by use of the router, an upwardly curving ramp portion is formed leading away from the hole in the insert through which the router bits operates towards an outlet through which the debris will tend to be directed by action of centrifugal forces.

59. An attachment according to claim 57 wherein a flexible sealing ring of individual fibres is anchored to a circular ring mounted within the plenum chamber, further wherein each fibre is angled in the direction of the rotation of a router cutter thereby allowing the fibre to be deflected sideways when a cutter passes though the seal.

60. A router apparatus in combination with a router control attachment according to claim 46.

61. A router apparatus in combination with a router control attachment according to claim 50.

62. A method of making a sealing ring in which a ball of deformable material is placed within an inner ring and spaced apart from a larger ring by means of breakable spokes; fibre or wire is wound around the ring and the ball in a series of loops or turns to produce the desired density of fibre material, the wound ring is then placed in an injection moulding machine which simultaneously moulds an outer ring around the component to encapsulate and anchor the fibres, crush and rotate the ball thus breaking the temporary spokes, the fibres are then cut to form inner aperture and the inner ring and ball removed to obtain a flat sealing element.

63. A router attachment according to claim 46 in combination with a sealing ring made by a method in which a ball of deformable material is placed within an inner ring and spaced apart from a larger ring by means of breakable spokes; fibre or wire is wound around the ring and the ball in a series of loops or turns to produce the desired density of fibre material, the wound ring is then placed in an injection moulding machine which simultaneously moulds an outer ring around the component to encapsulate and anchor the fibres, crush and rotate the ball thus breaking the temporary spokes, the fibres are then cut to form inner aperture and the inner ring and ball removed to obtain a flat sealing element.

64. A device for controlling in incremental steps the depth of cut of a router blade in a router apparatus wherein the router comprises a router body and a base plate, said device comprising a hollow tube, bracket or cartridge around the outside of which there is positioned a series of incremental spiral steps.

65. A router attachment according to claim 46 in combination with a device for controlling in incremental steps the depth of cut of a router blade in a router apparatus wherein the router comprises a router body and a base plate, said device comprising a hollow tube, bracket or cartridge around the outside of which there is positioned a series of incremental spiral steps.

66. A depth control for attachment to a router apparatus, which router apparatus comprises a router body and a base plate, wherein said depth control comprises a control bar attached to the base plate which can be moved relative to the base plate; the router body being able to slide relative to the control bar and the router body being lockable to the control bar so that, when the router body is locked to the control bar, vertical adjustment of the control bar will adjust the depth of a router cut by a corresponding amount.

67. A router attachment according to claim 46 in combination with a depth control for attachment to a router apparatus, which router apparatus comprises a router body and a base plate, wherein said depth control comprises a control bar attached to the base plate which can be moved relative to the base plate; the router body being able to slide relative to the control bar and the router body being lockable to the control bar so that, when the router body is locked to the control bar, vertical adjustment of the control bar will adjust the depth of a router cut by a corresponding amount.

68. A device for controlling in incremental steps the depth of cut by a router blade in a router apparatus wherein said router apparatus comprises a router body and a base plate, said device comprising a hollow tube, bracket or cartridge adapted to be rotatably mounted to a base plate of a router; around the outside of said hollow tube, bracket or cartridge are a series of incremental spiral steps in which the tube, bracket or cartridge, when incorporated in a router apparatus, can control the depth of cut by movement of an engagement means attached to the router apparatus so as to engage with the spiral steps to prevent further downward movement of the router and cutter, so that, in use, rotation of the tube, bracket or cartridge causes the attachment means to move down the spiral steps in incremental stages and the router blade to move a corresponding distance downwards.

69. A router attachment according to claim 46 in combination with a device for controlling in incremental steps the depth of cut by a router blade in a router apparatus wherein said router apparatus comprises a router body and a base plate, said device comprising a hollow tube, bracket or cartridge adapted to be rotatably mounted to a base plate of a router; around the outside of said hollow tube, bracket or cartridge are a series of incremental spiral steps in which the tube, bracket or cartridge, when incorporated in a router apparatus, can control the depth of cut by movement of an engagement means attached to the router apparatus so as to engage with the spiral steps to prevent further downward movement of the router and cutter, so that, in use, rotation of the tube, bracket or cartridge causes the attachment means to move down the spiral steps in incremental stages and the router blade to move a corresponding distance downwards.
